(19) United States
(12) Patent Application Publication
(10) Pub. No.: US 2026/0164500 A1
(43) Pub. Date: Jun. 11, 2026

(54) RADIO FREQUENCY IDENTIFICATION (RFID) AND WIRELESS WIDE AREA NETWORK (WWAN) CONCURRENCY MANAGEMENT

(71) Applicant: QUALCOMM Incorporated, San Diego, CA (US)

(72) Inventors: Ajay Vignesh JAYAPRAKASH, San Diego, CA (US); Sayak SAHA, San Diego, CA (US); Kiran PATIL, San Diego, CA (US); Bhupesh Manoharlal UMATT, San Diego, CA (US); Scott HOOVER, Del Mar, CA (US); Sheng-Yuan TU, San Diego, CA (US); Chetan Jagdeesh BHARADWAJ, Erie, CO (US); Qi FU, San Diego, CA (US); Rishav REJ, Pleasanton, CA (US)

(21) Appl. No.: 18/975,833

(22) Filed: Dec. 10, 2024

(51) Int. Cl. H04W 76/28; H04B 7/06; H04W 28/02; H04W 52/36

(52) U.S. Cl. CPC H04W 76/28; H04B 7/0632; H04W 28/0278; H04W 52/365

(57) ABSTRACT

Disclosed are techniques for wireless communication, which may be performed by a UE or other device capable of wireless wide area network (WWAN) communication and radio frequency identification (RFID) communication. In some aspects, the RFID operation is scheduled to occur during a discontinuous reception (DRX) cycle OFF period, e.g., during DRX sleep periods. In some aspects, the device can request the network to change the device's DRX configuration so that there are DRX sleep periods of sufficient duration in which the RFID operation may occur. In some aspects, the device can force a change in DRX operation by throttling the WWAN operation. In some aspects, the relative priority of WWAN and RFID transmissions are alternated according to a duty cycle, which causes the RF chain to toggle between WWAN operation and RFID operation.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes determining that radio frequency identification (RFID) communication is needed; configuring the UE for a discontinuous reception (DRX) mode; and performing RFID communication during a DRX OFF period.

In an aspect, a method of wireless communication performed by a user equipment (UE) includes determining that radio frequency identification (RFID) communication is needed; determining that a discontinuous reception (DRX) mode is not available or DRX duration is not sufficient for RFID operation; and periodically alternating between a wireless wide area network (WWAN) communication mode and an RFID communication mode and performing RFID communication during the RFID communication mode.

In an aspect, a user equipment (UE) includes one or more memories; one or more transceivers; and one or more processors communicatively coupled to the one or more memories and the one or more transceivers, the one or more processors, either alone or in combination, being configured to: determine that radio frequency identification (RFID) communication is needed; configure the UE for a discontinuous reception (DRX) mode; and perform RFID communication during a DRX OFF period.

In an aspect, a user equipment (UE) includes one or more memories; one or more transceivers; and one or more processors communicatively coupled to the one or more memories and the one or more transceivers, the one or more processors, either alone or in combination, being configured to: determine that radio frequency identification (RFID) communication is needed; determine that a discontinuous reception (DRX) mode is not available or DRX duration is not sufficient for RFID operation; and periodically alternate between a wireless wide area network (WWAN) communication mode and an RFID communication mode and perform RFID communication during the RFID communication mode.

In an aspect, a user equipment (UE) includes means for determining that radio frequency identification (RFID) communication is needed; means for configuring the UE for a discontinuous reception (DRX) mode; and means for performing RFID communication during a DRX OFF period.

In an aspect, a user equipment (UE) includes means for determining that radio frequency identification (RFID) communication is needed; means for determining that a discontinuous reception (DRX) mode is not available or DRX duration is not sufficient for RFID operation; and means for periodically alternating between a wireless wide area network (WWAN) communication mode and an RFID communication mode and for performing RFID communication during the RFID communication mode.

In an aspect, a non-transitory computer-readable medium storing computer-executable instructions that, when executed by a user equipment (UE), cause the UE to: determine that radio frequency identification (RFID) communication is needed; configure the UE for a discontinuous reception (DRX) mode; and perform RFID communication during a DRX OFF period.

In an aspect, a non-transitory computer-readable medium storing computer-executable instructions that, when executed by a user equipment (UE), cause the UE to: determine that radio frequency identification (RFID) communication is needed; determine that a discontinuous reception (DRX) mode is not available or DRX duration is not sufficient for RFID operation; and periodically alternate between a wireless wide area network (WWAN) communication mode and an RFID communication mode and performing RFID communication during the RFID communication mode.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIGS. 4A-4C illustrate example discontinuous reception (DRX) configurations, according to aspects of the disclosure.

FIG. 5 is a diagram of an example architecture of a passive radio frequency identification (RFID) scenario, according to aspects of the disclosure.

FIG. 6 is a diagram illustrating an example of an RFID inventory sequence, according to aspects of the disclosure.

FIGS. 7-11 illustrate methods of RFID and WWAN concurrency management, according to aspects of the disclosure.

FIG. 12 is a flow chart illustrating a method of RFID and WWAN concurrency management, according to aspects of the disclosure.

FIGS. 13-14 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless communication. Some aspects more specifically relate to concurrent operation of wireless wide area network (WWAN) communications and radio frequency identification (RFID) communications. In some aspects, the RFID operation is scheduled to occur during a DRX cycle OFF period, e.g., during DRX sleep periods. In some aspects, the reader can request a change in DRX configuration so that there are sufficient DRX sleep periods in which the RFID operation may occur, and in response to that request, the network can change the DRX configuration to add or increase DRX sleep periods. In some aspects, the reader can induce CONNECTED mode DRX (CDRX) cycle OFF periods or other changes in DRX operation by throttling the WWAN operation. In some aspects, the relative priority of WWAN and RFID transmissions are alternated according to a duty cycle, which causes the RF chain to toggle between “WWAN frequencies and modes” and “RFID frequencies and modes,” in an operation referred to herein as a “tuneaway.” In some aspects, this mode is a fallback mode that is used when RFID operation during DRX sleep periods is not available. Each of these techniques will be discussed in more detail below.

Particular aspects of the subject matter described in this disclosure can be implemented to realize one or more of the following potential advantages. In some examples, by making use of DRX OFF periods for RFID transmissions, WWAN communications and RFID communications can coexist without significant impairment of either and without requiring the provision of a second radio frontend or additional amplifiers, filters, or antennas. This capability is particularly useful for RFID multi-tag tasks such as taking inventory, reading multiple products as they pass on a conveyor belt, or other applications in which a reader must read multiple RFID tags.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

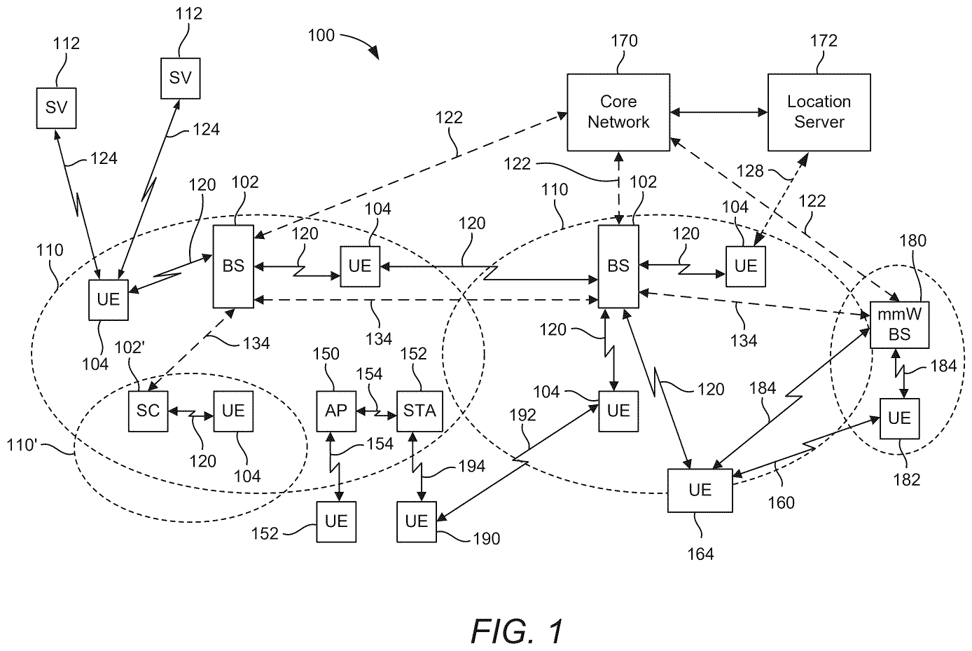

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz- 52.6 GHz). It should be understood that although a portion of FR1 is greater than 6 GHz, FR1 is often referred to (interchangeably) as a “Sub- 6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz- 300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1: M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example, an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

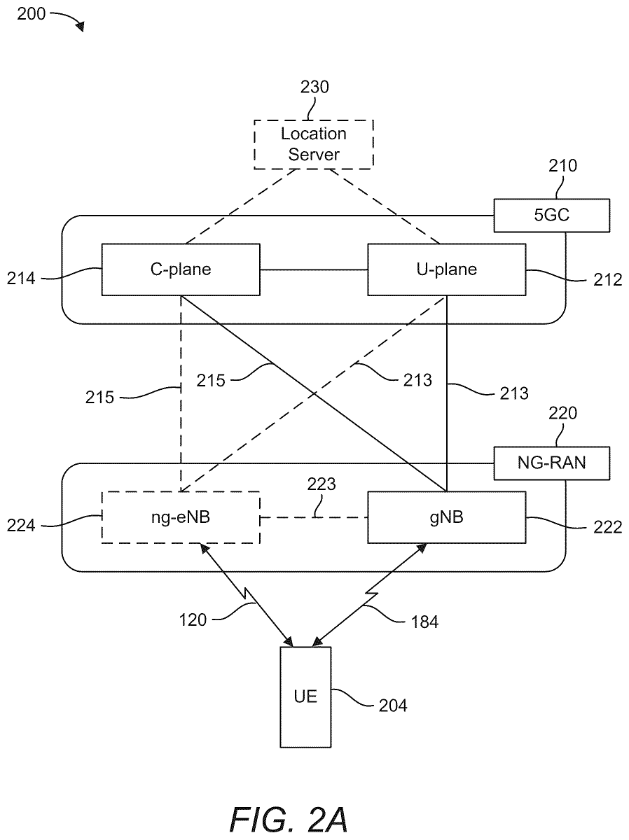

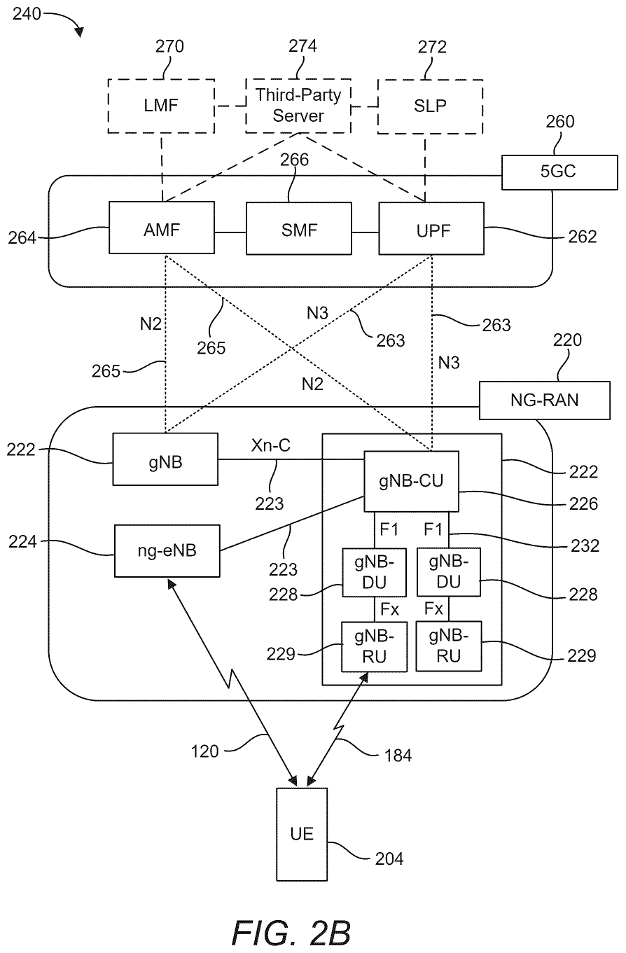

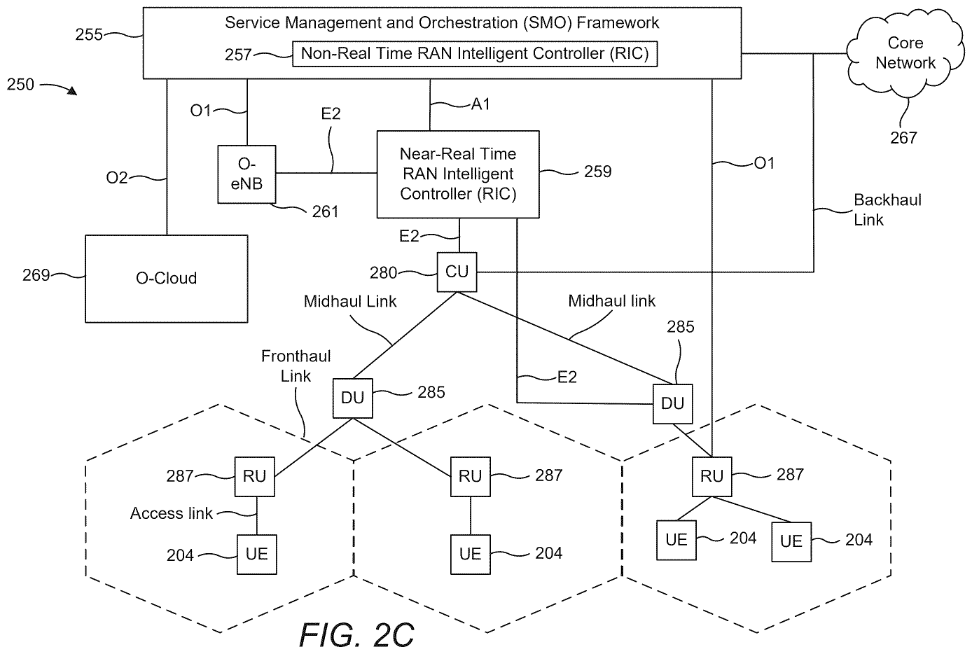

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

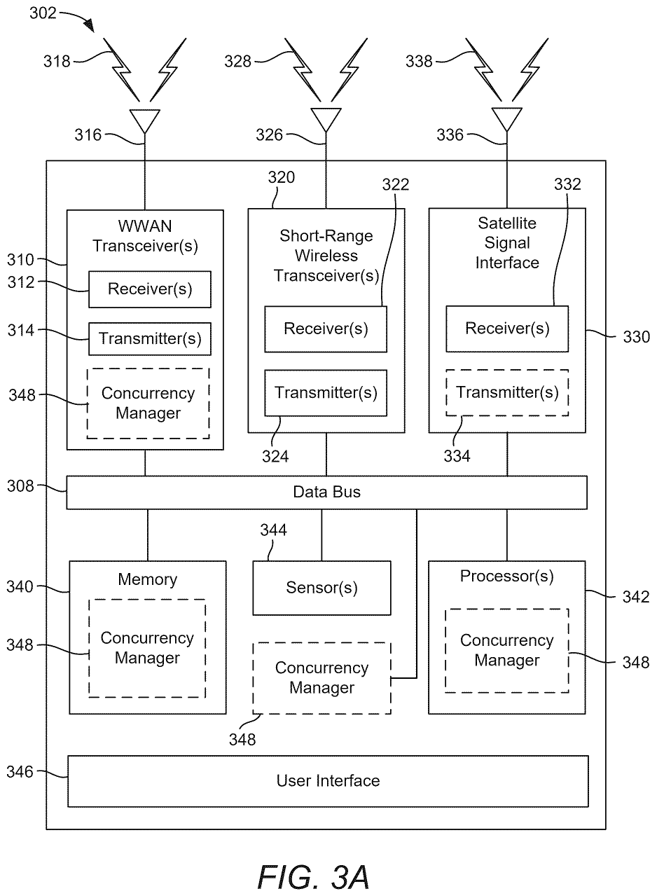

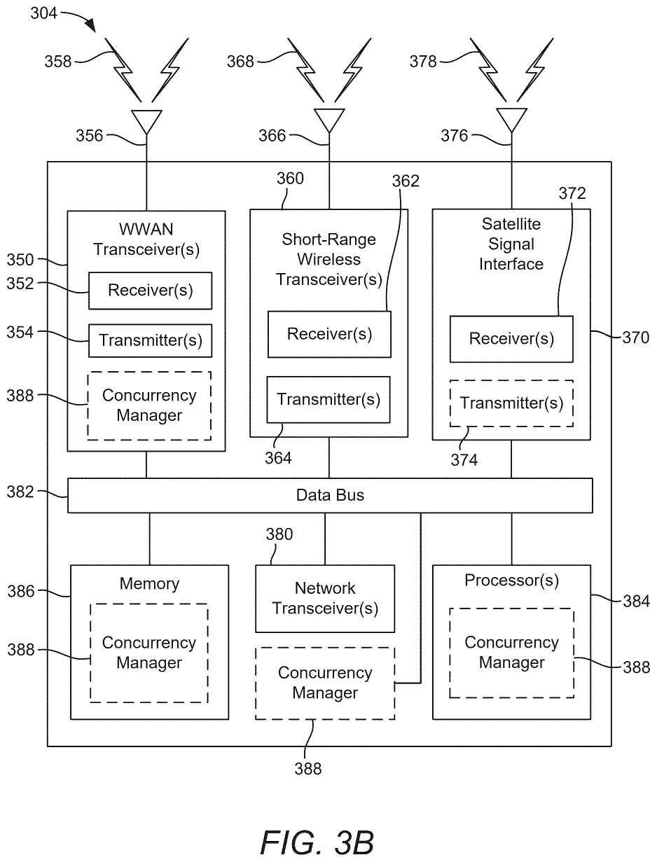

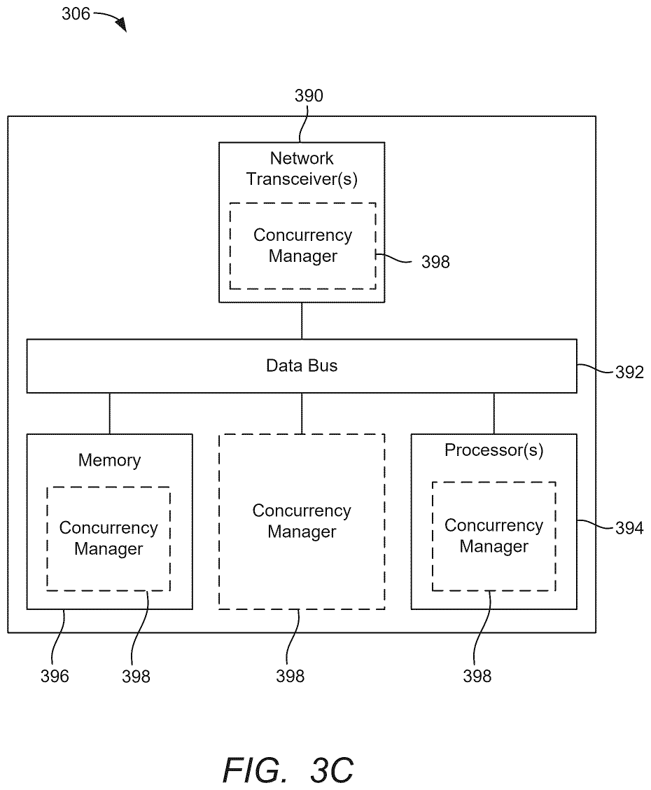

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include concurrency module 348, 388, and 398, respectively. The concurrency module 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the concurrency module 348, 388, and 398 may be external to the processors 342, 384, and 394 (e.g., part of a modem processing system, integrated with another processing system, etc.). Alternatively, the concurrency module 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the concurrency module 348, which may be, for example, part of the one or more WWAN transceivers 310, the memory 340, the one or more processors 342, or any combination thereof, or may be a standalone component. FIG. 3B illustrates possible locations of the concurrency module 388, which may be, for example, part of the one or more WWAN transceivers 350, the memory 386, the one or more processors 384, or any combination thereof, or may be a standalone component. FIG. 3C illustrates possible locations of the concurrency module 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A-3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the concurrency module 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

Even when there is no traffic being transmitted from the network to a UE, the UE is expected to monitor every downlink subframe on the physical downlink control channel (PDCCH). This means that the UE has to be “on,” or active, all the time, even when there is no traffic, since the UE does not know exactly when the network will transmit data for it. However, being active all the time is a significant power drain for a UE.

To address this issue, a UE may implement discontinuous reception (DRX) and/or connected-mode discontinuous reception (CDRX) techniques. DRX and CDRX are mechanisms in which a UE goes into a “sleep” mode for a scheduled periods of time and “wakes up” for other periods of time. During the wake, or active, periods, the UE checks to see if there is any data coming from the network, and if there is not, goes back into sleep mode.

To implement DRX and CDRX, the UE and the network need to be synchronized. In a worst-case scenario, the network may attempt to send some data to the UE while the UE is in sleep mode, and the UE may wake up when there is no data to be received. To prevent such scenarios, the UE and the network should have a well-defined agreement about when the UE can be in sleep mode and when the UE should be awake/active. This agreement has been standardized in various technical specifications. Note that DRX includes CDRX, and thus, references to DRX refer to both DRX and CDRX, unless otherwise indicated.

The network (e.g., serving cell) can configure the UE with the DRX/CDRX timing using an RRC Connection Reconfiguration message (for CDRX) or an RRC Connection Setup message (for DRX). The network can signal the following DRX configuration parameters to the UE. (1) DRX Cycle: The duration of one ‘ON time’ plus one ‘OFF time.’ This value is not explicitly specified in RRC messages; rather, it is calculated by the subframe/slot time and “long DRX cycle start offset.” (2) ON Duration Timer: The duration of ‘ON time’ within one DRX cycle. (3) DRX Inactivity Timer: How long a UE should remain ‘ON’ after the reception of a PDCCH. When this timer is on, the UE remains in the ‘ON state,’ which may extend the ON period into the period that would be the ‘OFF’ period otherwise. (4) DRX Retransmission Timer: The maximum number of consecutive PDCCH subframes/slots a UE should remain active to wait for an incoming retransmission after the first available retransmission time. (5) Short DRX Cycle: A DRX cycle that can be implemented within the ‘OFF’ period of a long DRX cycle. (6) DRX Short Cycle Timer: The consecutive number of subframes/slots that should follow the short DRX cycle after the DRX inactivity timer has expired.

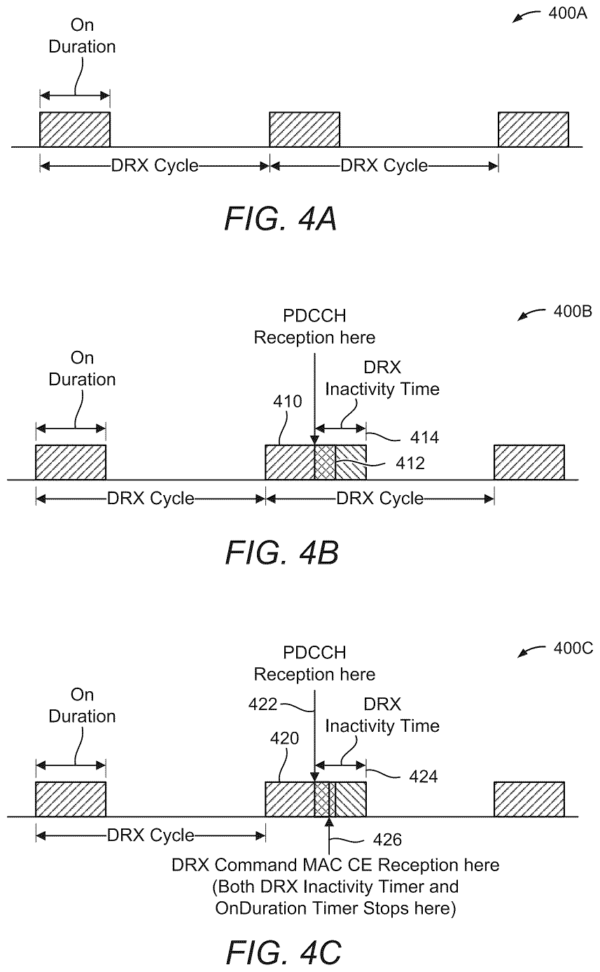

FIG. 4A illustrates an example DRX configuration 400A in which a long DRX cycle (the time from the start of one ON duration to the start of the next ON duration) is configured and no PDCCH is received during the cycle.

FIG. 4B illustrates an example DRX configuration 400B in which a long DRX cycle is configured and a PDCCH is received during an ON duration 410 of the second DRX cycle illustrated. Note that the ON duration 410 ends at time 412. However, the time that the UE is awake/active (the “active time”) is extended to time 414 based on the length of the DRX inactivity timer and the time at which the PDCCH is received. Specifically, when the PDCCH is received, the UE starts the DRX inactivity timer and stays in the active state until the expiration of that timer (which is reset each time a PDCCH is received during the active time).

FIG. 4C illustrates an example DRX configuration 400C in which a long DRX cycle is configured and a PDCCH and a DRX command MAC control element (MAC-CE) are received during an ON duration 420 of the second DRX cycle illustrated. Note that the active time beginning during ON duration 420 would normally end at time 424 due to the reception of the PDCCH at time 422 and the subsequent expiration of the DRX inactivity timer at time 424, as discussed above with reference to FIG. 4B. However, in the example of FIG. 4C, the active time is shortened to time 426 based on the time at which the DRX command MAC-CE, which instructs the UE to terminate the DRX inactivity timer and the ON duration timer, is received.

In greater detail, the active time of a DRX cycle is the time during which the UE is considered to be monitoring the PDCCH. The active time may include the time during which the ON duration timer is running, the DRX inactivity timer is running, the DRX retransmission timer is running, the MAC contention resolution timer is running, a scheduling request has been sent on the PUCCH and is pending, an uplink grant for a pending HARQ retransmission can occur and there is data in the corresponding HARQ buffer, or a PDCCH indicating a new transmission addressed to the cell radio network temporary identifier (C-RNTI) of the UE has not been received after successful reception of a random access response (RAR) for the preamble not selected by the UE. And, in non-contention-based random access, after receiving the RAR, the UE should be in an active state until the PDCCH indicating new transmission addressed to the C-RNTI of the UE is received.

Radio frequency identification (RFID) is a rapidly growing technology impacting many industries benefiting from automatic identity capture and management due to its economic potential for asset/inventory/resource management inside and outside the warehouse, machine to machine scenarios, IoT scenarios, sustainable sensor networks in factories and/or agriculture, smart homes, and the like. RFID consists of small transponders, or “tags,” that emit an information-bearing signal upon receiving an energizing signal. RFID “readers” emit energizing signals to activate and “read” the information stored by RFID tags. RFID tags can be attached to inventory items or other assets to track the assets' movements through the supply chain. RFID tags can be operated without battery at low operating expense, low maintenance cost, and long-life cycle.

There are different types of RFID tags: passive, semi-passive, and active. Passive tags have no power source, and instead receive energy signals from an RFID reader or harvest energy from ambient wireless signals to power the transmission/reception circuitry, where the transmitted signal is typically backscatter modulated. Passive tags therefore have limited computational capacity and no ability for advanced signal processing (e.g., analog-to-digital converter (ADC), digital-to-analog converter (DAC)). Semi-passive tags have an on-board limited power source that can be used to energize their microchip. Active tags have an on-board power source and are able to transmit whether a reader is transmitting within their range or not.

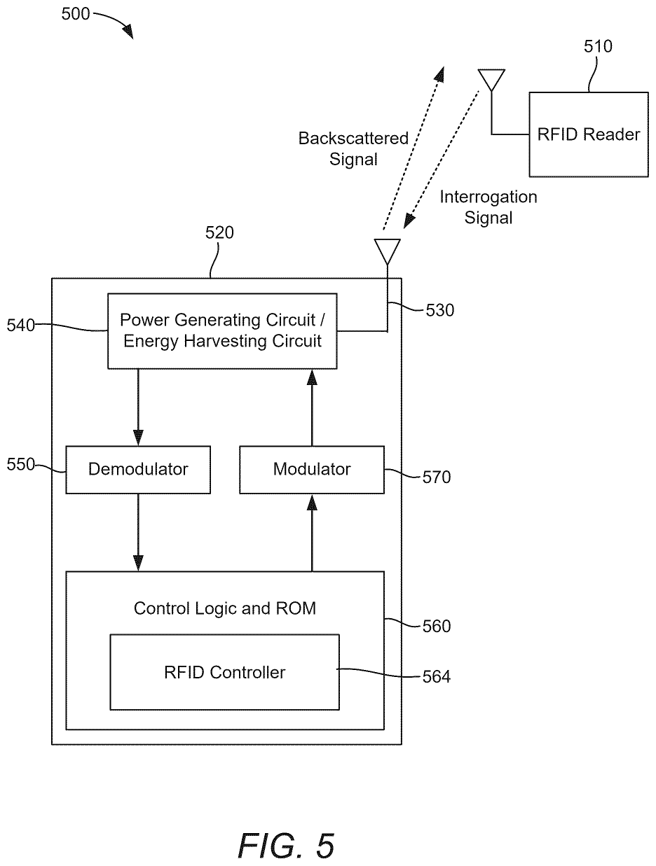

FIG. 5 is a diagram 500 of an example architecture of a passive RFID scenario, according to aspects of the disclosure. As shown in FIG. 5, an RFID reader device 510 transmits an energy signal (referred to herein as an “interrogation signal”) towards a passive RFID tag 520. An antenna 530 of the passive RFID tag 520 receives the interrogation signal. A power generating circuit 540 (also referred to as an energy harvesting circuit) extracts power/energy from the received interrogation signal and supplies power to all the components of the passive RFID tag 520. The demodulator 550 demodulates the interrogation signal and transmits the demodulated signal to the control logic 560 (e.g., an application-specific integrated circuit (ASIC)) for processing. The control logic 560 may also include a read-only memory (ROM) (not shown) and an RFID controller 564 configured to cause the passive RFID tag 520, in conjunction with the other components, to perform the operations described herein. The control logic 560 generates a response signal and transmits it to the modulator 570, which generates a modulated backscattered signal and transmits it to the power generating circuit 540. The power generating circuit 540 then transmits the backscattered signal over the antenna 530.

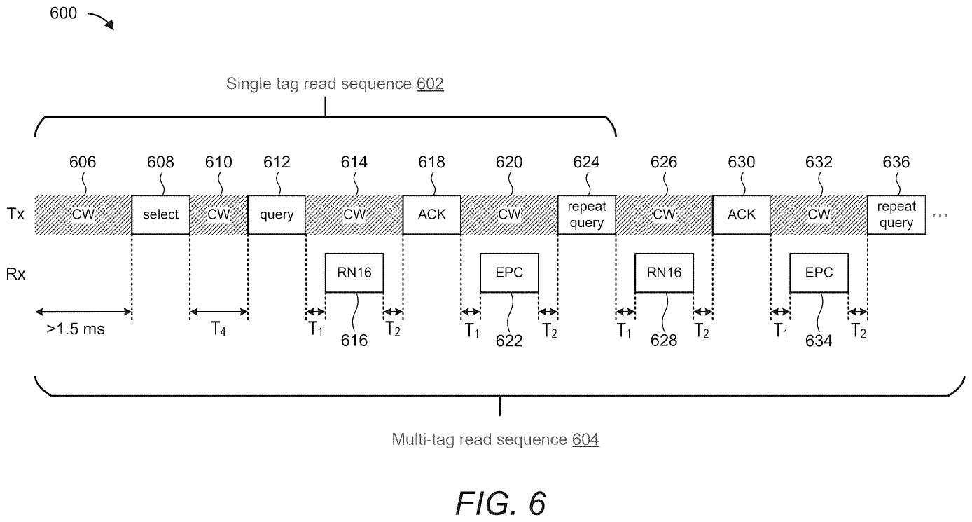

FIG. 6 is a diagram 600 illustrating an example of an RFID inventory sequence, according to aspects of the disclosure. In the example shown in FIG. 6, each tag is associated with an item in inventory, and each item is identified by an electronic product code (EPC). FIG. 6 shows an example inventory process in which a reader issues a query and one or more tags respond to the reader by providing the EPC stored within that tag.

FIG. 6 depicts time-division duplexing from the perspective of a reader that includes alternating transmissions (Tx), such as continuous wave (CW) transmissions and command transmissions, and reception (Rx) of messages from an energy harvesting device such as a tag. One or more RFID tags may be read in sequence. Diagram 600 includes example single tag read sequence 602 and multi-tag read sequence 604.

In the example shown in FIG. 6, the single tag read sequence 602 and the multi-tag read sequence 604 include a sequence of various transmissions and receptions from the reader's perspective. The sequence 602 and the sequence 604 are exemplary and not limiting; other variations are possible. It will be understood that a transmission from the reader is a reception by the tag and vice versa.

The sequence 602 and the sequence 604 each include various CW segments, during which the reader emits a continuous wave via an antenna. A tag may charge an embedded capacitor during a CW segment, which can enable the tag to respond during subsequent time periods. The sequence 602 and the sequence 604 also each include various receive segments, during which the device listens for transmissions from the one or more RFID tags. The CW energizes any tags within range, or if the tags are already energized, maintains the tags energized before the tags are read. An RFID tag can “transmit” data to the reader by modulating the reflections of the CW being transmitted by the reader at that time. The reader detects the modulated reflection of the CW and extracts from it the data being transmitted by the tag to the reader.

In the example shown in FIG. 6, the single tag read sequence 602 includes a first CW segment 606 having a duration of at least 1.5 ms in order energize any tags within range, but other durations are possible. This is followed by a select command 608, a second CW segment 610 having a duration of time T4, and a query 612. This is followed by a third CW segment 614, during which a tag transmits a 16-bit random number (RN16) 616 by modulating the reflection of the CW being transmitted by the reader during the third CW segment 614. The reader detects the modulated reflection and extracts the RN16 data from it. The reader later acknowledges receipt of the RN16, via the ACK 618. A fourth CW segment 620 is transmitted, during which the tag transmits data, which in this example is an electronic product code (EPC) 622 by modulating the reflection of the CW being transmitted by the reader during the fourth CW segment 620. The reader then transmits the query again, as repeat query 624. This sequence of “transmit a query, transmit a CW segment during which an RN16 message is received, transmit an ACK, and transmit another CW segment during which an EPC message is received, and transmit a repeat query” is used to read one tag.

As shown in FIG. 6, the tag begins transmitting the RN16 message 616 T1 time after the start of the third CW segment 614 and ends the transmits T2 time before the end of the third CW segment 614, while the reader continues to transmit the third CW segment 614. As shown in FIG. 6, the tag begins transmitting the EPC message 622 T1 time after the start of the fourth CW segment 620 and ends the transmits T2 time before the end of the fourth CW segment 620, while the reader continues to transmit the fourth CW segment 620. The RFID specification provides for a potentially short turnaround time for timers T1 and T2. This short turnaround time causes a need for substantial computational resources, in addition to at least one antenna for RFID application. In some cases, meeting additional requirements may be required. Such requirements may include FHSS spectrum signaling for UL in the USA and a need to meet anti-jammer requirements in the European Union (EU).

In the example shown in FIG. 6, the multi-tag read sequence 604 includes all of the components of the single tag read sequence 602 with additional feature that the repeat query 624 serves to query the next tag in a multi-tag read sequence. The “transmit the repeat query, transmit a CW segment during which an RN16 message is received, transmit an ACK, and transmit another CW segment during which an EPC message is received” is repeated as many times as needed in order to give all tags within range a chance to respond to the reader. In the example shown in FIG. 6, repeat query 624 starts a query of the next tag, followed by transmitting a fifth CW segment 626, during which a second tag transmits another RN 16 628, which is received by the reader and later acknowledged by the reader via the ACK 630. A sixth CW segment 632 is transmitted, during which the second tag transmits its EPC 634. In the example shown in FIG. 6, the query is again repeated as query 636, which starts an interaction with a third tag, followed by an interaction with additional tags as needed. These messages may be repeated, once for each additional tag.

A duration of the sequences depends on a particular configuration that the reader selects for transmit and receive data transmissions. In an example, a typical duration of the single tag read sequence 602 is from 1.2-50 ms. In contrast, the duration of a multi-tag read sequence 604 may range according to the formula ({1.2-50}+(number of tags read)*{0.5-41})ms. For both single tag and multi-tag read sequences, at least 1.5 ms of continuous wave transmission may be needed at the beginning to power up tags before sending any commands.

UEs and other 3G/4G/5G telecommunication devices transmit and receive OFDM signals, which occupy specified frequency ranges called subcarriers. It is desirable that these telecommunications devices also support RFID functionality, e.g., to operate as an RFID reader. To do so, such devices must be able to process or modulate CW signals and/or receive and demodulate signals received from an RFID tag or energy harvesting device. However, RFID requires the transmit circuit to be ON continuously to provide the CW signal that powers the tags and allows the reader to interact with them. This may interfere with WWAN transmit and receive functions and can cause severe performance degradation, or even dropped calls. Moreover, both WWAN and RFID operations may be triggered concurrently by end-user actions, such as starting an RFID scan while on a 4G/5G data call. In this scenario, the device needs to be able to operate in both WWAN mode and in RFID mode simultaneously.

However, there may be hardware limitations that prevent simultaneous operation in both RFID and WWAN modes. Such limitations may include, but are not limited to, the need for both RFID and WWAN transmissions to share a transmit power amplifier (PA), the need for both RFID and WWAN receivers to share a low noise amplifier (LNA), the need for both RFID and WWAN to use the same antennas, switches, or other RF front end components. One solution is to provide separate, dedicated hardware for each of the RFID and WWAN RF chains, but this dual radio solution is very costly in terms of hardware. Thus, for single radio solutions, there is a need to intelligently share RF components for both WWAN and RFID transmission modes in a manner that allows both WWAN and RFID modes to operate concurrently, i.e., in a manner that two modes to use the same single radio RF hardware in a time shared fashion.

Accordingly, techniques for RFID and WWAN concurrency management are herein presented. In some aspects, the RFID operation is scheduled to occur during a DRX cycle OFF period, e.g., during DRX sleep periods. In some aspects, the reader can request a change in DRX configuration so that there are sufficient DRX sleep periods in which the RFID operation may occur, and in response to that request, the network can change the DRX configuration to add or increase DRX sleep periods. In some aspects, the reader can force a change in DRX operation, e.g., to force CDRX OFF periods, by throttling the WWAN operation. In some aspects, the relative priority of WWAN and RFID transmissions are alternated according to a duty cycle, which causes the RF chain to toggle between “WWAN frequencies and modes” and “RFID frequencies and modes,” in an operation referred to herein as a “tuneaway.” In some aspects, this mode is a fallback mode that is used when RFID operation during DRX sleep periods is not available or DRX duration is not sufficient for RFID operation. Each of these techniques will be discussed in more detail below.

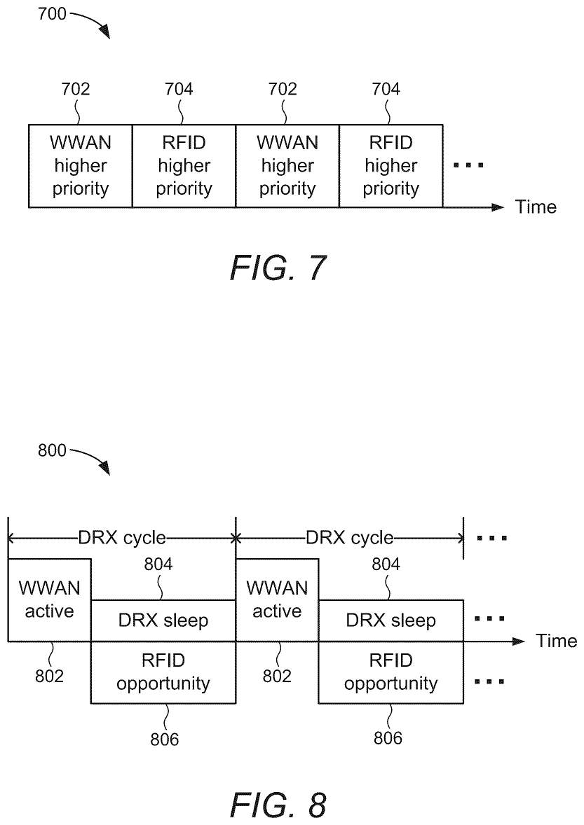

FIG. 7 illustrates a method 700 of RFID and WWAN concurrency management, according to aspects of the disclosure. In this method 700, the priority of WWAN operations and RFID operations are switched periodically, e.g., according to a duty cycle. During a first part of the duty cycle 702, the WWAN operation has higher priority, and during the second part of the duty cycle 704, the RFID operation has priority. When the WWAN operation has higher priority, the RF circuit is tuned away from the RFID frequencies to the WWAN frequencies, and when the RFID operation has higher priority, the RF circuit is tuned away from the WWAN frequencies to the RFID frequencies. In some aspects, the duty cycle repeats for as long as RFID operation is needed. In some aspects, the duty cycle is static with no provision to adjust the relative WWAN and RFID durations on the fly based on other factors. As a result, this method 700 may be used as a fallback method if other methods are unavailable. For example, in some aspects, this method 700 may be used as the default option if other approaches described herein do not provide a sufficient duration of time for an RFID session.

FIG. 8 illustrates a method 800 of RFID and WWAN concurrency management, according to aspects of the disclosure. In this method 800, the device is already in the IDLE camped state with a long paging cycle (e.g., 640 ms or 1280 ms) and thus is in DRX mode, or is in CONNECTED mode with low traffic (e.g., a voice call or data with a low data rate) and thus is in CDRX mode. Such as device will have a DRX cycle comprising a WWAN active time period 802 and a DRX sleep time period 804. In this method 800, the RFID operation is scheduled to occur during a DRX cycle OFF period, e.g., during DRX sleep time periods 804. These are referred to as RFID opportunities 806, since they may or may not be used for RFID operation, depending on the RFID needs at the time.

This ensures no performance loss for WWAN, while ensuring that RFID operations run while the WWAN is not active, i.e., only during the RFID opportunities 806. This also ensures that when RFID activities are suspended, they are resumed within a prescribed time limit for a tag to resume interactions with a reader, e.g., within 2 seconds, based on the procedure, session ID, etc. During that time limit, a tag will retain its state information, flags status, etc., so that it can resume the interaction with the reader.

In some aspects, upon a request for an RFID operation, which may be triggered by a user action, a request by an application, etc., it is determined whether the WWAN is in an IDLE or CONNECTED DRX mode configured with periodic wakeup for paging or other idle mode activities. If the WWAN is currently in an IDLE DRX mode, then RFID operations can be scheduled during the IDLE DRX sleep occasions. If the WWAN is in a CONNECTED DRX mode but currently in a low data rate or voice call, then the RFID operations can be scheduled during the next CDRX sleep occasion. During either the IDLE or CONNECTED DRX sleep period, the next wakeup occasion from the WWAN will end the RFID operation to allow the WWAN to wake up.

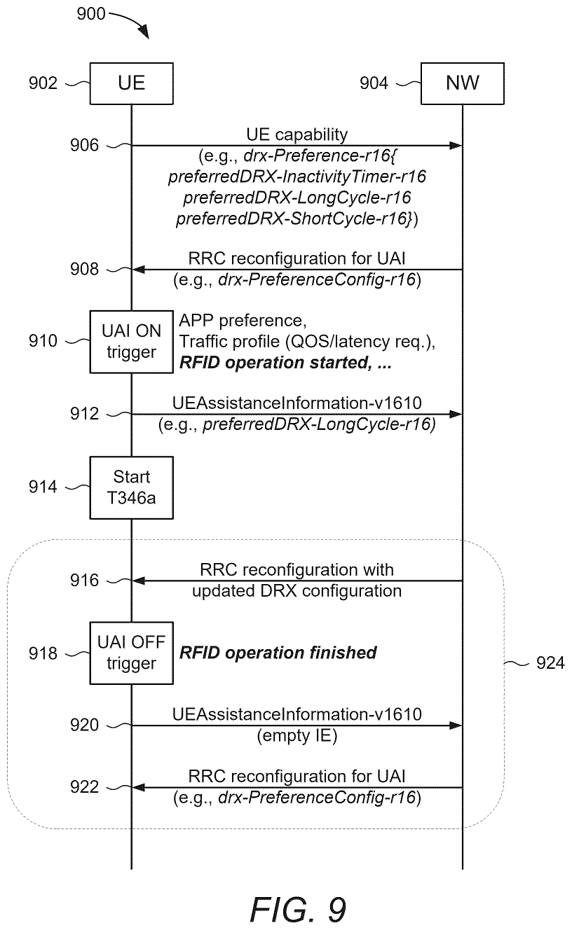

Release 16 of the 3GPP 5G standards (R16) allows a UE that is camped on a 5G cell or on an active 5G call to indicate to the network that it wants to change a DRX preference, such as “preferredDRX-LongCycle-r16”, “preferredDRX-ShortCycle-r16”, and “preferredDRX-InactivityTimer-r16”. The UE can indicate this preference by sending UE assistance information (UAI) to the network. R16 does not contemplate using this mechanism for any purpose related to RFID operations, however. Accordingly, in some aspects, this mechanism is expanded such that a UAI can be issued in response to starting an RFID operation. In some aspects, in response to starting an RFID operation, a UE can transmit a UAI that requests a long or longer DRX cycle. An example of this operation is illustrated in FIG. 9.

FIG. 9 illustrates a method 900 of RFID and WWAN concurrency management, according to aspects of the disclosure. FIG. 9 illustrates an interaction between a 5G new radio (NR) device, e.g., a UE 902 that supports RFID operation and a network (NW) 904 in which the UE 902 is operating. In this example, the UE 902 requests a change in DRX configuration so that there are sufficient DRX sleep periods in which an RFID operation may occur.

In example shown in FIG. 9, at block 906, the UE 902 provides UE capability information to the NW 904. In some aspects, this UE capability information indicates that the UE 902 can support RFID operations. In some aspects, the UE capability information includes a drx-Preference element that specifies DRX preferences, which may include, but are not limited to, parameters such as “preferredDRX-LongCycle-r16”, “preferredDRX-ShortCycle-r16”, and “preferredDRX-InactivityTimer-r16”.

In the example shown in FIG. 9, at block 908, the NW 904 transmits an RRC configuration for UAI to the UE 902. This may include a DRX configuration information element (IE) such as “drx-PreferenceConfig-r16”.

In the example shown in FIG. 9, at block 910, the UE 902 detects a UAI ON trigger, which in this example is that an RFID operation has started or will soon start. In response to detecting that an RFID operation has started or will soon start, at block 912 the UE 902 sends a UAI message that requests a change to the current DRX configuration, and at block 914, the UE 902 starts a timer that must expire before the UE 902 can send out another UAI message. In the example shown in FIG. 9, at block 912 the UE 902 sends a UEAssistanceInformation-r16 IE indicating a new preferredDRX-LongCycle-r16 value, and at block 914, the UE starts timer T346a.

In the example shown in FIG. 9, the NW 904 responds to the DRX configuration change request: at block 916, the NW 904 sends to the UE 902 a RRC reconfiguration with an updated DRX configuration that provides a long or longer DRX sleep cycle during which the UE 902 can perform an RFID operation.

In the example shown in FIG. 9, at block 918, the RFID operation is finished. At block 920, the UE 902 notifies the NW 904 that it no longer needs the longer DRX sleep cycle, e.g., by sending a UAI message with an empty IE. At block 922, the NW 904 sends another RRC reconfiguration for UAI message, e.g., to reset the DRX configuration to the previous configuration or to a new configuration that does not have such a long DRX sleep cycle. The blocks 916, 918, 920, and 922 of FIG. 9 illustrate an example of a CDRX override 924 that was executed so that the UE 902 could perform WWAN communication and RFID communication concurrently.

However, in other aspects, the original request to change the DRX configuration at block 912 of FIG. 9 may be denied by the NW 904. For example, the UE 902 may be in the middle of a high data rate call and therefore not in a DRX mode at all. In this scenario, the NW 904 may refuse to configure the UE 902 into a DRX mode, or, if the UE 902 is in a DRX mode, the NW 904 may refuse to lengthen the DRX sleep cycle to a duration needed by the UE 902 to perform the RFID operation. In some aspects, the UE 902 must then wait for the expiry of the timer (e.g., timer T346a), then send another UAI message to request a change in the DRX configuration. In some aspects, if the second request is also rejected or ignored, then the UE 902 may fall back to a priority toggling method such as method 700 in FIG. 7.

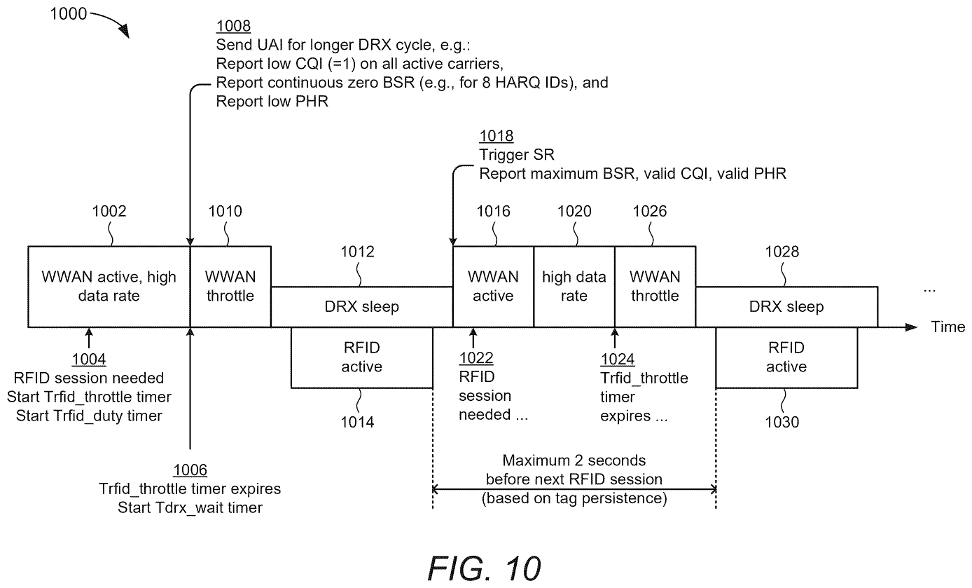

Alternatively, in some aspects, the UE 902 may force or induce the NW 904 to enter a DRX mode so that the UE 902 can perform the desired RFID operation, using a technique referred to herein as WWAN throttling. An example of this is shown in FIG. 10.

FIG. 10 illustrates a method 1000 of RFID and WWAN concurrency management, performed by a UE or other network entity with RFID reader capabilities, according to aspects of the disclosure. In the example illustrated in FIG. 10, the UE may induce a longer CDRX sleep duration, even during a WWAN data (non-voice) call, by inducing CDRX sleep on the WWAN side. Once CDRX mode has been established, the CDRX sleep periods may be used for RFID operations.

In the example illustrated in FIG. 10, the UE's WWAN is initially in an active state with a high data rate time period 1002, which is preventing CDRX sleep. During that active time period 1002, at time 1004 the UE determines that an RFID session is needed. In order to execute the RFID session, the UE needs to switch the WWAN to a reduced data rate mode. This action is referred to herein as throttling the WWAN or putting the WWAN into a throttled mode.

In 4G and 5G networks this can be done by reporting a low, non-zero (e.g., 1.0, 2.0, . . . ) channel quality information (CQI) on all active carriers, by reporting a zero buffer status report (BSR) continuously for all hybrid automatic repeat requests (HARQs), or by reporting a low power headroom report (PHR) value, which indicate to a network that the UE could be at the edge of cell coverage or unable to handle a high data rate. In response, the network usually throttles the data rate, which would result in CDRX sleep. In a low data rate mode, the WWAN is expected to enter DRX sleep after the CDRX timers expire. Once the WWAN is in DRX sleep, the UE can utilize this window to schedule RFID sessions and yield to WWAN before the next CDRX ON cycle starts.

In the example illustrated in FIG. 10, at time 1004 the UE detects that an RFID session is needed, and in response starts an RFID throttle timer (e.g., “Trfid_throttle”) and an RFID duty timer (e.g., “Trfid_duty”). The RFID throttle timer expiry will trigger a WWAN throttling process to switch to a low data rate so that a CDRX mode will be entered and a DRX sleep period will become available for RFID communication. The RFID throttle timer value will be chosen based on the CDRX cycle length, to ensure RFID procedure can resume within the maximum allowed time during which an RFID tag must retain its session information and state flags (e.g., 2 seconds). The RFID duty timer will be used to toggle the priorities of the WWAN and RFID communication modes as shown in FIG. 7, if necessary. Typically, the RFID throttle timer period will be shorter than the RFID duty cycle timer period.

In the example illustrated in FIG. 10, at time 1006 the RFID throttle timer expires, and start DRX wait timer (e.g., “Tdrx_wait”) is started. At time 1008, the UE will begin a WWAN throttling process by sending a UAI that reports a low CQI for all active carriers, reports continuous zero BSR for all HARQ IDs, and reports low PHR. This triggers entry into a WWAN throttle period 1010, which triggers the network to reconfigure the UE into a DRX mode. The UE later enters a DRX sleep period 1012, e.g., in response to expiry of a CDRX timer. RFID communication 1014 can then occur during the DRX sleep period 1012.

In the example illustrated in FIG. 10, the DRX sleep period is known to the UE, which pauses any RFID sessions to allow for the WWAN communication to resume in WWAN active period 1016. In the example illustrated in FIG. 10, at time 1018, the UE will issue a scheduling request (SR) to the network to get an UL grant. Once the UL grant is received, the UE will report a maximum BSR (e.g., stating that there is data in the UL buffers), a valid CQI, and a valid PHR. The updated BSR, CQI, and PHR values will eventually result in the UE entering a high data rate period 1020.

In the example illustrated in FIG. 10, at time 1022 the UE determines that an existing RFID session should continue and/or a new RFID session is needed. In the example illustrated in FIG. 10, an RFID throttle timer is started at time 1022 and expires at time 1024, at which time the UE will execute the WWAN throttling process described above. In the example shown in FIG. 10, the UE enters into a WWAN throttle period 1026, which triggers the network to reconfigure the UE into a DRX mode. The UE later enters a DRX sleep period 1028, during which RFID communication 1030 can occur.

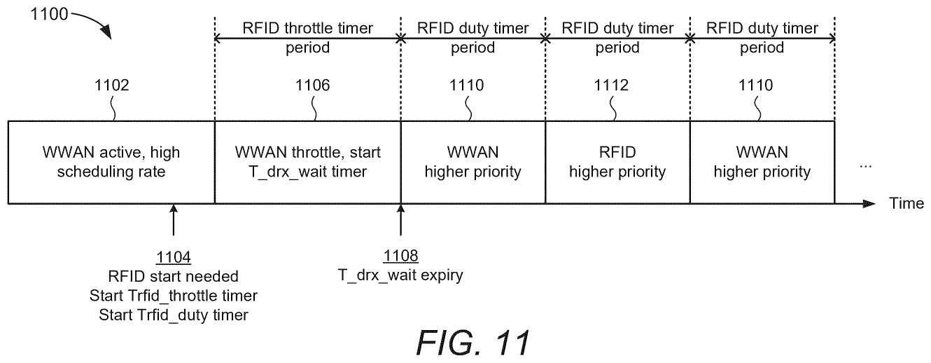

FIG. 11 illustrates a method 1100 of RFID and WWAN concurrency management, according to aspects of the disclosure. The method 1100 may be used as a fallback method, e.g., where the WWAN throttling technique shown in FIG. 10 does not work. In the example shown in FIG. 11, during time period 1102 the WWAN of the UE is in an active state with a high scheduling rate. At time 1104, an RFID start is needed, so during time period 1106, the WWAN is throttled, e.g., using the techniques described above with regard to FIG. 10, but the network does not configure or reconfigure the device to have a DRX sleep mode of sufficient duration for RFID communication, or does not configure or reconfigure the device to have a DRX sleep mode at all.

In the example illustrated in FIG. 11, at time 1108 the DRX wait time expires, but the network has not configured the UE to have a DRX sleep period. Thus, at time 1108 the UE switches to a default duty cycle mode that comprises alternating WWAN periods 1110 in which WWAN communication has higher priority than RFID communication and RFID periods 1112 in which RFID communication has higher priority than WWAN communication.

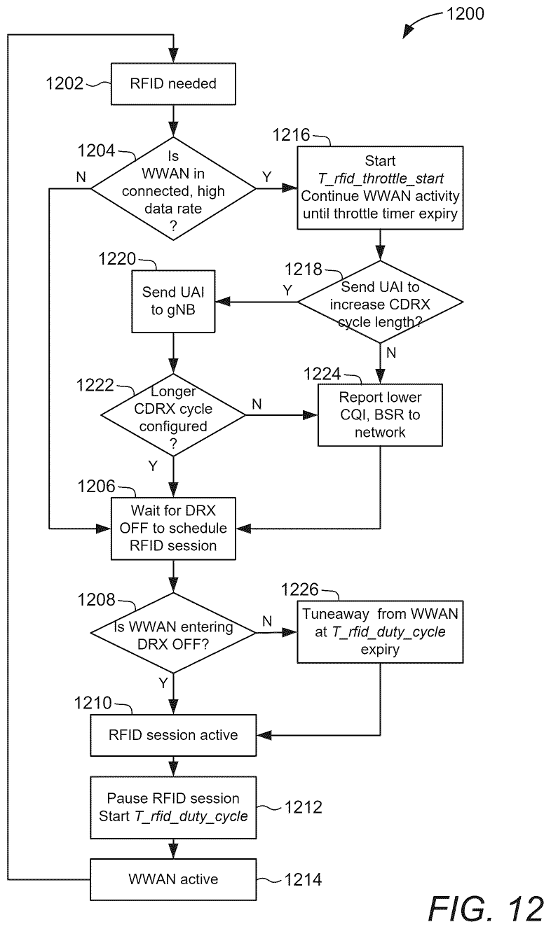

FIG. 12 is a flowchart 1200 illustrating a method for RFID and WWAN concurrency management, according to aspects of the disclosure. In some aspects, this method is performed by a UE with RFID reader capabilities. In the example illustrated in FIG. 12, at block 1202, it is determined that RFID communication is needed. At block 1204, the UE checks whether the WWAN is in CONNECTED mode with a high data rate; if not, then at block 1206 the UE schedules an RFID session during an upcoming DRX OFF period. At block 1208, the WWAN enters the DRX OFF period and at block 1210, the RFID session becomes active. At block 1212, the RFID session is paused and an RFID duty cycle timer is started, and at block 124, the WWAN is active. If an RFID session is needed again, the process resumes at block 1202. In this manner, the UE waits for DRX OFF to schedule RFID sessions, and yields back to WWAN before the next DRX wakeup.

At block 1204, if the WWAN is in CONNECTED mode with a high data rate, then at block 1216, an RFID throttle timer is started and WWAN activity continues until the RFID throttle timer expires. In some aspects, the RFID throttle timer duration will be less than 2 seconds to allow tags to resume sessions with persisted data. After the RFID throttle timer expires, at block 1218 it is decided whether to request that the network change a DRX configuration to increase CDRX cycle length. If it is decided to request that the network make that change, then at block 1220, the UE sends a UAI to the gNB to increase the CDRX cycle length.

At block 1222, the UE then checks to see if the network has configured a longer CDRX cycle for the UE. If the network has configured a longer DRX cycle for the UE, then the process goes to block 1206 and waits for a DRX OFF period in which to schedule the RFID session. If, at block 1222, the network has not configured a longer DRX cycle for the UE, then at block 1224, the UE takes action to throttle the WWAN, such as reporting a lower CQI, BSR, or PHR to the network. This will usually trigger the UE to be configured into a DRX mode. The process then goes to block 1206 to wait for the DRX OFF period. At block 1208 the WWAN enters DRX OFF, and at block 1210, the RFID session is active. At block 1212, the RFID session is paused, and at block 1214 the WWAN is active. In this scenario, where the UE took action to throttle the WWAN by sending a lower CQI, BSR, or PHR to the network, at block 1212 the UE may report a higher CQI, BSR, or PHR to the network to allow the WWAN active mode to run at a high data rate.

In some instances, such as legacy technology such as 4G, it is not possible for the network to configure a longer DRX cycle. In other scenarios, the network denies the request to configure a longer DRX cycle. Thus, at block 1208, if the network has not configured a longer DRX cycle for the UE (regardless of the specific reason), if it is determined that the WWAN is not entering DRX OFF, then at block 1226, the default mode is entered wherein the RFID communication and WWAN communication have alternating priority relative to each other. At the expiry of the RFID duty cycle timer, the WWAN session is forced to have lower priority than the RFID session, which triggers a tuneaway from WWAN to RFID mode and activates the RFID session at block 1210. At the next expiry of the RFID duty cycle timer, the RFID session is forced to have lower priority than the WWAN session, which triggers a tuneaway from RFID to WWAN mode and activates the WWAN session at block 1214. The UE continues to alternate between WWAN sessions and RFID sessions until this default mode is disabled.

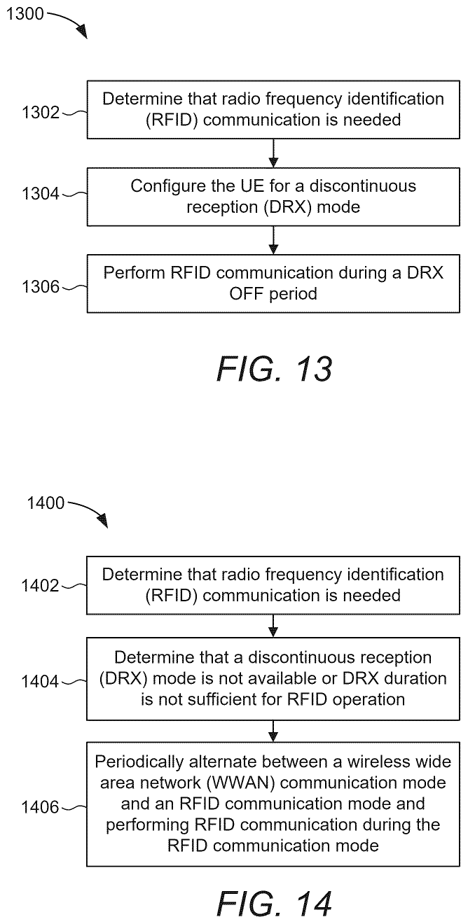

FIG. 13 is a flowchart of an example method 1300 of wireless communication, according to aspects of the disclosure. In an aspect, method 1300 may be performed by a user equipment (UE) (e.g., any UE described herein).

As shown in FIG. 13, method 1300 may include, at block 1302, determining that radio frequency identification (RFID) communication is needed. In an aspect where the method 1300 is performed by a UE 302, the operation of block 1302 may be performed by the one or more WWAN transceivers 310, the one or more short-range wireless transceivers 320, the one or more processors 342, and/or the concurrency manager 348, any or all of which may be considered means for performing this operation. In an aspect, the operation of block 1302 may be performed by the processor(s), memory, or transceiver(s) of any of the apparatuses described herein.

As further shown in FIG. 13, method 1300 may include, at block 1304, configuring the UE for a discontinuous reception (DRX) mode. In an aspect where the method 1300 is performed by a UE 302, the operation of block 1304 may be performed by the one or more WWAN transceivers 310, the one or more short-range wireless transceivers 320, the one or more processors 342, and/or the concurrency manager 348, any or all of which may be considered means for performing this operation. In an aspect, the operation of block 1304 may be performed by the processor(s), memory, or transceiver(s) of any of the apparatuses described herein.

As further shown in FIG. 13, method 1300 may include, at block 1306, performing RFID communication during a DRX OFF period. In an aspect where the method 1300 is performed by a UE 302, the operation of block 1306 may be performed by the one or more WWAN transceivers 310, the one or more short-range wireless transceivers 320, the one or more processors 342, and/or the concurrency manager 348, any or all of which may be considered means for performing this operation. In an aspect, the operation of block 1306 may be performed by the processor(s), memory, or transceiver(s) of any of the apparatuses described herein.

In some aspects, method 1300 includes pausing RFID communication before expiry of the DRX OFF period, waiting for a next DRX OFF period, and resuming RFID communication during the next DRX OFF period.

In some aspects, configuring the UE for the DRX mode comprises determining that the UE has a DRX configuration having a DRX OFF period of a length sufficient to perform the RFID communication, or determining that the UE has a DRX configuration having a DRX OFF period of a length not sufficient to perform the RFID communication, and triggering a change in the DRX configuration or DRX operation to increase the DRX OFF period duration.

In some aspects, triggering a change in the DRX configuration or DRX operation to increase the DRX OFF period duration comprises sending, to a network within which the UE is operating, a request to change the DRX configuration to increase the DRX OFF mode duration, and receiving, form the network, a change in the DRX configuration that increases the DRX OFF mode duration.

In some aspects, triggering a change in the DRX configuration or DRX operation to increase the DRX OFF period duration comprises sending, to a network within which the UE is operating, a request to change the DRX configuration to increase the DRX OFF mode duration, determining that the network did not change the DRX configuration to increase the DRX OFF mode operation, sending, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, and inducing a change in the DRX operation that increases the DRX OFF mode duration.

In some aspects, triggering a change in DRX configuration or DRX operation to increase the DRX OFF period duration comprises sending, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, and inducing a change in the DRX operation that increases the DRX OFF mode duration.

Method 1300 may include additional implementations, such as any single implementation or any combination of implementations described below and/or in connection with one or more other methods described elsewhere herein. Although FIG. 13 shows example blocks of method 1300, in some implementations, method 1300 may include additional blocks, fewer blocks, different blocks, or differently arranged blocks than those depicted in FIG. 13. Additionally, or alternatively, two or more of the blocks of method 1300 may be performed in parallel.

FIG. 14 is a flowchart of an example method 1400 of wireless communication, according to aspects of the disclosure. In an aspect, method 1400 may be performed by a UE (e.g., any UE described herein).

As shown in FIG. 14, method 1400 may include, at block 1402, determining that radio frequency identification (RFID) communication is needed. In an aspect where the method 1400 is performed by a UE 302, the operation of block 1402 may be performed by the one or more WWAN transceivers 310, the one or more short-range wireless transceivers 320, the one or more processors 342, and/or the concurrency manager 348, any or all of which may be considered means for performing this operation. In an aspect, the operation of block 1402 may be performed by the processor(s), memory, or transceiver(s) of any of the apparatuses described herein.

As further shown in FIG. 14, method 1400 may include, at block 1404, determining that a discontinuous reception (DRX) mode is not available or DRX duration is not sufficient for RFID operation. In an aspect where the method 1400 is performed by a UE 302, the operation of block 1404 may be performed by the one or more WWAN transceivers 310, the one or more short-range wireless transceivers 320, the one or more processors 342, and/or the concurrency manager 348, any or all of which may be considered means for performing this operation. In an aspect, the operation of block 1404 may be performed by the processor(s), memory, or transceiver(s) of any of the apparatuses described herein.

As further shown in FIG. 14, method 1400 may include, at block 1406, periodically alternating between a wireless wide area network (WWAN) communication mode and an RFID communication mode and performing RFID communication during the RFID communication mode. In an aspect where the method 1400 is performed by a UE 302, the operation of block 1406 may be performed by the one or more WWAN transceivers 310, the one or more short-range wireless transceivers 320, the one or more processors 342, and/or the concurrency manager 348, any or all of which may be considered means for performing this operation. In an aspect, the operation of block 1406 may be performed by the processor(s), memory, or transceiver(s) of any of the apparatuses described herein.

In some aspects, determining that a DRX mode is not available or DRX duration is not sufficient for RFID operation comprises sending, to a network within which the UE is operating, a request for a discontinuous reception (DRX) mode configuration, and determining that the network did not provide a DRX mode configuration.

In some aspects, determining that a DRX mode is not available or DRX duration is not sufficient for RFID operation comprises determining that the UE or a network within which the UE is operating does not support DRX.

In some aspects, periodically alternating between a wireless wide area network (WWAN) communication mode and an RFID communication mode comprises setting a WWAN communication priority higher than an RFID communication priority for a first portion of a period, setting the RFID communication priority higher than the WWAN communication priority for a second portion of the period, and repeating the period.

Method 1400 may include additional implementations, such as any single implementation or any combination of implementations described below and/or in connection with one or more other methods described elsewhere herein. Although FIG. 14 shows example blocks of method 1400, in some implementations, method 1400 may include additional blocks, fewer blocks, different blocks, or differently arranged blocks than those depicted in FIG. 14. Additionally, or alternatively, two or more of the blocks of method 1400 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), the method comprising: determining that radio frequency identification (RFID) communication is needed; configuring the UE for a discontinuous reception (DRX) mode; and performing RFID communication during a DRX OFF period.

Clause 2. The method of clause 1, further comprising: pausing RFID communication before expiry of the DRX OFF period; waiting for a next DRX OFF period; and resuming RFID communication during the next DRX OFF period.

Clause 3. The method of any of clauses 1 to 2, wherein configuring the UE for the DRX mode comprises: determining that the UE has a DRX configuration having a DRX OFF period of a length sufficient to perform the RFID communication; or determining that the UE has a DRX configuration having a DRX OFF period of a length not sufficient to perform the RFID communication, and triggering a change in the DRX configuration or DRX operation to increase the DRX OFF period duration.

Clause 4. The method of clause 3, wherein triggering a change in the DRX configuration or DRX operation to increase the DRX OFF period duration comprises: sending, to a network within which the UE is operating, a request to change the DRX configuration to increase the DRX OFF mode duration; and receiving, from the network, a change in the DRX configuration that increases the DRX OFF mode duration.

Clause 5. The method of any of clauses 3 to 4, wherein triggering a change in the DRX configuration or DRX operation to increase the DRX OFF period duration comprises: sending, to a network within which the UE is operating, a request to change the DRX configuration to increase the DRX OFF mode duration; determining that the network did not change the DRX configuration to increase the DRX OFF mode operation; sending, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value; and inducing a change in the DRX operation that increases the DRX OFF mode duration.

Clause 6. The method of any of clauses 3 to 5, wherein triggering a change in DRX configuration or DRX operation to increase the DRX OFF period duration comprises: sending, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, which induces a change in the DRX operation that increases the DRX OFF mode duration.

Clause 7. A method of wireless communication performed by a user equipment (UE), the method comprising: determining that radio frequency identification (RFID) communication is needed; determining that a discontinuous reception (DRX) mode is not available or DRX duration is not sufficient for RFID operation; and periodically alternating between a wireless wide area network (WWAN) communication mode and an RFID communication mode and performing RFID communication during the RFID communication mode.

Clause 8. The method of clause 7, wherein determining that a DRX mode is not available or DRX duration is not sufficient for RFID operation comprises: sending, to a network within which the UE is operating, a request for a discontinuous reception (DRX) mode configuration; and determining that the network did not provide a DRX mode configuration.

Clause 9. The method of any of clauses 7 to 8, wherein determining that a DRX mode is not available or DRX duration is not sufficient for RFID operation comprises determining that the UE or a network within which the UE is operating does not support DRX.

Clause 10. The method of any of clauses 7 to 9, wherein periodically alternating between a wireless wide area network (WWAN) communication mode and an RFID communication mode comprises setting a WWAN communication priority higher than an RFID communication priority for a first portion of a period, setting the RFID communication priority higher than the WWAN communication priority for a second portion of the period, and repeating the period.

Clause 11. A user equipment (UE), comprising: one or more memories; one or more transceivers; and one or more processors communicatively coupled to the one or more memories and the one or more transceivers, the one or more processors, either alone or in combination, being configured to: determine that radio frequency identification (RFID) communication is needed; configure the UE for a discontinuous reception (DRX) mode; and perform RFID communication during a DRX OFF period.

Clause 12. The UE of clause 11, wherein the one or more processors, either alone or in combination, are further configured to: pause RFID communication before expiry of the DRX OFF period; wait for a next DRX OFF period; and resume RFID communication during the next DRX OFF period.

Clause 13. The UE of any of clauses 11 to 12, wherein, to configure the UE for the DRX mode, the one or more processors, either alone or in combination, are configured to: determine that the UE has a DRX configuration having a DRX OFF period of a length sufficient to perform the RFID communication; or determine that the UE has a DRX configuration having a DRX OFF period of a length not sufficient to perform the RFID communication, and trigger a change in the DRX configuration or DRX operation to increase the DRX OFF period duration.

Clause 14. The UE of clause 13, wherein, to trigger a change in the DRX configuration or DRX operation to increase the DRX OFF period duration, the one or more processors, either alone or in combination, are configured to: send, via the one or more transceivers, to a network within which the UE is operating, a request to change the DRX configuration to increase the DRX OFF mode duration; and receive, via the one or more transceivers, from the network, a change in the DRX configuration that increases the DRX OFF mode duration.

Clause 15. The UE of any of clauses 13 to 14, wherein, to trigger a change in the DRX configuration or DRX operation to increase the DRX OFF period duration, the one or more processors, either alone or in combination, are configured to: send, via the one or more transceivers, to a network within which the UE is operating, a request to change the DRX configuration to increase the DRX OFF mode duration; determine that the network did not change the DRX configuration to increase the DRX OFF mode operation; send, via the one or more transceivers, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value; and induce a change in the DRX operation that increases the DRX OFF mode duration.

Clause 16. The UE of any of clauses 13 to 15, wherein, to trigger a change in DRX configuration or DRX operation to increase the DRX OFF period duration, the one or more processors, either alone or in combination, are configured to: send, via the one or more transceivers, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, which induces a change in the DRX operation that increases the DRX OFF mode duration.

Clause 17. A user equipment (UE), comprising: one or more memories; one or more transceivers; and one or more processors communicatively coupled to the one or more memories and the one or more transceivers, the one or more processors, either alone or in combination, being configured to: determine that radio frequency identification (RFID) communication is needed; determine that a discontinuous reception (DRX) mode is not available or DRX duration is not sufficient for RFID operation; and periodically alternate between a wireless wide area network (WWAN) communication mode and an RFID communication mode and perform RFID communication during the RFID communication mode.

Clause 18. The UE of clause 17, wherein, to determine that a DRX mode is not available or DRX duration is not sufficient for RFID operation, the one or more processors, either alone or in combination, are configured to: send, via the one or more transceivers, to a network within which the UE is operating, a request for a discontinuous reception (DRX) mode configuration; and determine that the network did not provide a DRX mode configuration.

Clause 19. The UE of any of clauses 17 to 18, wherein, to determine that a DRX mode is not available or DRX duration is not sufficient for RFID operation, the one or more processors, either alone or in combination, are configured to determine that the UE or a network within which the UE is operating does not support DRX.

Clause 20. The UE of any of clauses 17 to 19, wherein, to periodically alternate between a wireless wide area network (WWAN) communication mode and an RFID communication mode, the one or more processors, either alone or in combination, are configured to set a WWAN communication priority higher than an RFID communication priority for a first portion of a period, set the RFID communication priority higher than the WWAN communication priority for a second portion of the period, and repeat the period.

Clause 21. A user equipment (UE), comprising: means for determining that radio frequency identification (RFID) communication is needed; means for configuring the UE for a discontinuous reception (DRX) mode; and means for performing RFID communication during a DRX OFF period.

Clause 22. The UE of clause 21, further comprising: means for pausing RFID communication before expiry of the DRX OFF period; means for waiting for a next DRX OFF period; and means for resuming RFID communication during the next DRX OFF period.

Clause 23. The UE of any of clauses 21 to 22, wherein the means for configuring the UE for the DRX mode comprises: means for determining that the UE has a DRX configuration having a DRX OFF period of a length sufficient to perform the RFID communication; or means for determining that the UE has a DRX configuration having a DRX OFF period of a length not sufficient to perform the RFID communication and for triggering a change in the DRX configuration or DRX operation to increase the DRX OFF period duration.

Clause 24. The UE of clause 23, wherein the means for triggering a change in the DRX configuration or DRX operation to increase the DRX OFF period duration comprises: means for sending, to a network within which the UE is operating, a request to change the DRX configuration to increase the DRX OFF mode duration; and means for receiving, from the network, a change in the DRX configuration that increases the DRX OFF mode duration.

Clause 25. The UE of any of clauses 23 to 24, wherein the means for triggering a change in the DRX configuration or DRX operation to increase the DRX OFF period duration comprises: means for sending, to a network within which the UE is operating, a request to change the DRX configuration to increase the DRX OFF mode duration; means for determining that the network did not change the DRX configuration to increase the DRX OFF mode operation; means for sending, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, which induces a change in the DRX operation that increases the DRX OFF mode duration.

Clause 26. The UE of any of clauses 23 to 25, wherein the means for triggering a change in DRX configuration or DRX operation to increase the DRX OFF period duration comprises: means for sending, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, which induces a change in the DRX operation that increases the DRX OFF mode duration.

Clause 27. A user equipment (UE), comprising: means for determining that radio frequency identification (RFID) communication is needed; means for determining that a discontinuous reception (DRX) mode is not available or DRX duration is not sufficient for RFID operation; and means for periodically alternating between a wireless wide area network (WWAN) communication mode and an RFID communication mode and for performing RFID communication during the RFID communication mode.

Clause 28. The UE of clause 27, wherein the means for determining that a DRX mode is not available or DRX duration is not sufficient for RFID operation comprises: means for sending, to a network within which the UE is operating, a request for a discontinuous reception (DRX) mode configuration; and means for determining that the network did not provide a DRX mode configuration.

Clause 29. The UE of any of clauses 27 to 28, wherein the means for determining that a DRX mode is not available or DRX duration is not sufficient for RFID operation comprises means for determining that the UE or a network within which the UE is operating does not support DRX.

Clause 30. The UE of any of clauses 27 to 29, wherein the means for periodically alternating between a wireless wide area network (WWAN) communication mode and an RFID communication mode comprises means for setting a WWAN communication priority higher than an RFID communication priority for a first portion of a period, for setting the RFID communication priority higher than the WWAN communication priority for a second portion of the period, and for repeating the period.

Clause 31. A non-transitory computer-readable medium storing computer-executable instructions that, when executed by a user equipment (UE), cause the UE to: determine that radio frequency identification (RFID) communication is needed; configure the UE for a discontinuous reception (DRX) mode; and perform RFID communication during a DRX OFF period.

Clause 32. The non-transitory computer-readable medium of clause 31, further comprising computer-executable instructions that, when executed by the UE, cause the UE to: pause RFID communication before expiry of the DRX OFF period; wait for a next DRX OFF period; and resume RFID communication during the next DRX OFF period.

Clause 33. The non-transitory computer-readable medium of any of clauses 31 to 32, wherein the computer-executable instructions that, when executed by the UE, cause the UE to configure the UE for the DRX mode comprise computer-executable instructions that, when executed by the UE, cause the UE to: determine that the UE has a DRX configuration having a DRX OFF period of a length sufficient to perform the RFID communication; or determine that the UE has a DRX configuration having a DRX OFF period of a length not sufficient to perform the RFID communication, and trigger a change in the DRX configuration or DRX operation to increase the DRX OFF period duration.

Clause 34. The non-transitory computer-readable medium of clause 33, wherein the computer-executable instructions that, when executed by the UE, cause the UE to trigger a change in the DRX configuration or DRX operation to increase the DRX OFF period duration comprise computer-executable instructions that, when executed by the UE, cause the UE to: send, to a network within which the UE is operating, a request to change the DRX configuration to increase the DRX OFF mode duration; and receive, from the network, a change in the DRX configuration that increases the DRX OFF mode duration.

Clause 35. The non-transitory computer-readable medium of any of clauses 33 to 34, wherein the computer-executable instructions that, when executed by the UE, cause the UE to trigger a change in the DRX configuration or DRX operation to increase the DRX OFF period duration comprise computer-executable instructions that, when executed by the UE, cause the UE to: send, to a network within which the UE is operating, a request to change the DRX configuration to increase the DRX OFF mode duration; determine that the network did not change the DRX configuration to increase the DRX OFF mode operation; send, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, which induces a change in the DRX operation that increases the DRX OFF mode duration.

Clause 36. The non-transitory computer-readable medium of any of clauses 33 to 35, wherein the computer-executable instructions that, when executed by the UE, cause the UE to trigger a change in DRX configuration or DRX operation to increase the DRX OFF period duration comprise computer-executable instructions that, when executed by the UE, cause the UE to: send, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, which induces a change in the DRX operation that increases the DRX OFF mode duration.

Clause 37. A non-transitory computer-readable medium storing computer-executable instructions that, when executed by a user equipment (UE), cause the UE to: determine that radio frequency identification (RFID) communication is needed; determine that a discontinuous reception (DRX) mode is not available or DRX duration is not sufficient for RFID operation; and periodically alternate between a wireless wide area network (WWAN) communication mode and an RFID communication mode and performing RFID communication during the RFID communication mode.

Clause 38. The non-transitory computer-readable medium of clause 37, wherein the computer-executable instructions that, when executed by the UE, cause the UE to determine that a DRX mode is not available or DRX duration is not sufficient for RFID operation comprise computer-executable instructions that, when executed by the UE, cause the UE to: send, to a network within which the UE is operating, a request for a discontinuous reception (DRX) mode configuration; and determine that the network did not provide a DRX mode configuration.

Clause 39. The non-transitory computer-readable medium of any of clauses 37 to 38, wherein the computer-executable instructions that, when executed by the UE, cause the UE to determine that a DRX mode is not available or DRX duration is not sufficient for RFID operation comprise computer-executable instructions that, when executed by the UE, cause the UE to determine that the UE or a network within which the UE is operating does not support DRX.

Clause 40. The non-transitory computer-readable medium of any of clauses 37 to 39, wherein the computer-executable instructions that, when executed by the UE, cause the UE to periodically alternate between a wireless wide area network (WWAN) communication mode and an RFID communication mode comprise computer-executable instructions that, when executed by the UE, cause the UE to set a WWAN communication priority higher than an RFID communication priority for a first portion of a period, set the RFID communication priority higher than the WWAN communication priority for a second portion of the period, and repeat the period.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a user equipment (UE), the method comprising:
determining that radio frequency identification (RFID) communication is needed;
configuring the UE for a discontinuous reception (DRX) mode; and
performing RFID communication during a DRX OFF period.

2. The method of claim 1, further comprising:
pausing RFID communication before expiry of the DRX OFF period;
waiting for a next DRX OFF period; and
resuming RFID communication during the next DRX OFF period.

3. The method of claim 1, wherein configuring the UE for the DRX mode comprises:
determining that the UE has a DRX configuration having a DRX OFF period of a length sufficient to perform the RFID communication; or
determining that the UE has a DRX configuration having a DRX OFF period of a length not sufficient to perform the RFID communication, and triggering a change in the DRX configuration or DRX operation to increase the DRX OFF period duration.

4. The method of claim 3, wherein triggering a change in the DRX configuration or DRX operation to increase the DRX OFF period duration comprises:
sending, to a network within which the UE is operating, a request to change the DRX configuration to increase the DRX OFF mode duration; and
receiving, from the network, a change in the DRX configuration that increases the DRX OFF mode duration.

5. The method of claim 3, wherein triggering a change in the DRX configuration or DRX operation to increase the DRX OFF period duration comprises:
sending, to a network within which the UE is operating, a request to change the DRX configuration to increase the DRX OFF mode duration;
determining that the network did not change the DRX configuration to increase the DRX OFF mode operation;
sending, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value; and
inducing a change in the DRX operation that increases the DRX OFF mode duration.

6. The method of claim 3, wherein triggering a change in DRX configuration or DRX operation to increase the DRX OFF period duration comprises:
sending, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, which induces a change in the DRX operation that increases the DRX OFF mode duration.

7. A method of wireless communication performed by a user equipment (UE), the method comprising:
determining that radio frequency identification (RFID) communication is needed;
determining that a discontinuous reception (DRX) mode is not available or DRX duration is not sufficient for RFID operation; and
periodically alternating between a wireless wide area network (WWAN) communication mode and an RFID communication mode and performing RFID communication during the RFID communication mode.

8. The method of claim 7, wherein determining that a DRX mode is not available or DRX duration is not sufficient for RFID operation comprises:
sending, to a network within which the UE is operating, a request for a discontinuous reception (DRX) mode configuration; and
determining that the network did not provide a DRX mode configuration.

9. The method of claim 7, wherein determining that a DRX mode is not available or DRX duration is not sufficient for RFID operation comprises determining that the UE or a network within which the UE is operating does not support DRX.

10. The method of claim 7, wherein periodically alternating between a wireless wide area network (WWAN) communication mode and an RFID communication mode comprises setting a WWAN communication priority higher than an RFID communication priority for a first portion of a period, setting the RFID communication priority higher than the WWAN communication priority for a second portion of the period, and repeating the period.

11. A user equipment (UE), comprising:
one or more memories;
one or more transceivers; and
one or more processors communicatively coupled to the one or more memories and the one or more transceivers, the one or more processors, either alone or in combination, being configured to:
determine that radio frequency identification (RFID) communication is needed;
configure the UE for a discontinuous reception (DRX) mode; and
perform RFID communication during a DRX OFF period.

12. The UE of claim 11, wherein the one or more processors, either alone or in combination, are further configured to:
pause RFID communication before expiry of the DRX OFF period;
wait for a next DRX OFF period; and
resume RFID communication during the next DRX OFF period.

13. The UE of claim 11, wherein, to configure the UE for the DRX mode, the one or more processors, either alone or in combination, are configured to:
determine that the UE has a DRX configuration having a DRX OFF period of a length sufficient to perform the RFID communication; or
determine that the UE has a DRX configuration having a DRX OFF period of a length not sufficient to perform the RFID communication, and trigger a change in the DRX configuration or DRX operation to increase the DRX OFF period duration.

14. The UE of claim 13, wherein, to trigger a change in the DRX configuration or DRX operation to increase the DRX OFF period duration, the one or more processors, either alone or in combination, are configured to:
send, via the one or more transceivers, to a network within which the UE is operating, a request to change the DRX configuration to increase the DRX OFF mode duration; and
receive, via the one or more transceivers, from the network, a change in the DRX configuration that increases the DRX OFF mode duration.

15. The UE of claim 13, wherein, to trigger a change in the DRX configuration or DRX operation to increase the DRX OFF period duration, the one or more processors, either alone or in combination, are configured to:
send, via the one or more transceivers, to a network within which the UE is operating, a request to change the DRX configuration to increase the DRX OFF mode duration;
determine that the network did not change the DRX configuration to increase the DRX OFF mode operation;
send, via the one or more transceivers, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value; and
induce a change in the DRX operation that increases the DRX OFF mode duration.

16. The UE of claim 13, wherein, to trigger a change in DRX configuration or DRX operation to increase the DRX OFF period duration, the one or more processors, either alone or in combination, are configured to:
send, via the one or more transceivers, to a network within which the UE is operating, information indicating at least one of a low, non-zero channel quality information (CQI) on all active carriers, a zero buffer status report (BSR) for all hybrid automatic repeat requests (HARQs), or a low power headroom report (PHR) value, which induces a change in the DRX operation that increases the DRX OFF mode duration.
